(19) United States
(12) Patent Application Publication
(10) Pub. No.: US 2017/0292412 A1
(43) Pub. Date: Oct. 12, 2017

(54) Aircraft Engine Heat Recovery System to Power Environmental Control Systems

(71) Applicant: Eduardo E. Fonseca, San Antonio, TX (US)

(72) Inventor: Eduardo E. Fonseca, San Antonio, TX (US)

(21) Appl. No.: 15/416,702

(22) Filed: Jan. 26, 2017

Related U.S. Application Data
(63) Continuation-in-part of application No. 14/239,455, filed on Feb. 18, 2014, now abandoned.
Application No. 14/239,455 is a continuation of application No. 12/912,911, filed on Oct. 27, 2010, now abandoned.
(60) Provisional application No. 61/255,433, filed on Oct. 27, 2009.

(51) Int. Cl. F01K 23/10; F01K 11/02; F01K 7/16; F01D 15/10; F01D 15/08

(52) U.S. Cl. CPC F01K 23/10; F01D 15/10; F01D 15/08; F01K 7/16; F01K 11/02; F05D 2220/323; F05D 2220/31; F05D 2220/62; F05D 2220/64; B64D 13/08

(57) ABSTRACT

A heat recovery system for an engine having an exhaust nozzle whereby exhaust gas is expelled, the heat recovery system comprising a steam generator that supplies hot vaporized coolant to a turbine generator which creates electrical energy. The electrical energy is used to power air compressors that supply clean outside air to the passenger compartment of the aircraft.

### PRIORITY CLAIM

This application claims priority to U.S. Non-Provisional patent application Ser. No. 14/239,455, with a filing date of Feb. 18, 2014. This application is a continuation-in-part of the cited application. The cited application is a National Stage Entry application based on PCT application PCT/US11/31508, filed on Apr. 7, 2011, which claimed priority to U.S. nonprovisional application Ser. No. 12/912,911 filed on Oct. 27, 2010, which claimed priority to U.S. application No. 61/255,433, filed on Oct. 27, 2009. All priority applications are hereby incorporated by reference.

### TECHNICAL FIELD

This invention relates to a specially-designed heat recovery system for use with an aircraft engine. The invention utilizes otherwise wasted heat energy in the form of exhaust gas from a gas turbine engine and uses that recovered energy to generate electricity which is used to power an environmental control system for the aircraft's passenger and crew compartments. The invention may also improve fuel efficiency.

### BACKGROUND ART

Most commercial passenger aircraft use jet engines which create very high temperature exhaust gases (e.g., about 800° K.). The jet engine also creates very high temperature air as a result of the combustion process. In a typical aircraft, a small percentage of the hot air in the engine high pressure air compressor is bled off and used for other purposes. Some of this engine bleed air is used to prevent icing of the wings and engine cowlings. Engine bleed air is also used to supply conditioned air (e.g., warmed, filtered, dried, etc.) to the passenger compartment of the aircraft. The engine bleed air is very hot, however, and must be cooled before it is introduced into the passenger compartment.

Engine bleed air may also be contaminated with compressor gases, which typically include unburned hydrocarbons, engine oil vapors, and vaporized hydraulic fluid. These contaminants are hazardous is inhaled or ingested by humans, so the engine bleed air must be filtered before it is used in the aircraft's environmental control system. But even with the best available filtering, some contaminants will remain in the air that is introduced into the passenger compartment.

The contamination of the passenger compartment air with hydrocarbon vapors poses a serious health risk to the persons within the aircraft. Because the contamination levels are typically low, short-term exposure may not cause healthy problems in most health persons. But long-term exposure and even short-term exposure by persons with compromised immune systems, asthma, or other breathing problems may create an unacceptable health risk.

One of the newest aircraft made today, the Boeing 787, does not use engine bleed air to supply air to the passenger compartment. The new Boeing 787 uses electrically-powered air compressors that draw air from outside the aircraft. This new system eliminates the health risks posed by the standard engine bleed air systems. But the new Boeing system was designed into the new aircraft from very early in the design process.

The Boeing 787 uses a pair of large electrical generators powered through a geared connection to the shaft of the jet engine turbines. In the new Boeing 787, most major aircraft functions are electrical, including the brakes and other high-load systems. This design requires the use of very large electrical generators, which place an added load on the engines, and therefore reduce the fuel efficiency of the aircraft. The Boeing system works well, but it cannot be used in a retrofit situation and it may result in increased fuel consumption.

There are thousands of commercial aircraft in use today, and many more being fabricated, with engine bleed air systems supplying air to the passenger compartments. These systems need to be replaced. It is not practical or cost-effective to retire all of these aircraft, many of which have many more years of use ahead of them. An alternative to the engine bleed air system is needed that is relatively low-cost, is simple to implement as a retrofit, that is reliable, and that will not reduce the efficiency of the aircraft's engines. The present invention provides just such a system.

### OBJECTS OF THE INVENTION

It is an object of the invention to provide a heat recovery system for an engine to utilize wasted heat energy from engine exhaust gases.

It is yet another object of the invention to provide a heat recovery system for an engine to utilize wasted heat energy from engine exhaust gases to power a compressor.

It is still another object of the invention to provide a heat recovery system for an engine to utilize wasted heat energy from engine exhaust gases to power a generator.

It is a further object of the invention to provide clean outside air to the passenger compartment of an aircraft, with the environmental control system being powered by a heat recovery system.

### DISCLOSURE OF THE INVENTION

According to an embodiment of the present invention, a heat recovery system is configured to capture wasted energy in the form of heat recovered from exhaust gas in an exhaust nozzle of an airplane engine. The heat energy converts fluid into vapor which then can turn a turbine generator which can power various components such as a generator or can be operatively connected to the engine shaft. In a preferred embodiment, the invention has a steam generator within a jet engine exhaust nozzle that supplies hot vaporized coolant to a turbine generator. The electricity produced by the turbine generator is used to power air compressors, which supply outside air to the passenger compartment. The heat recovery components of the invention are specially-designed in size and weight to work with an aircraft jet engine and are suitable for installation in a retrofit situation. The invention may be tailored to any aircraft and engine combination with minor modifications.

### BRIEF DESCRIPTION OF THE FIGURES

FIG. 1 is an interior view of an airplane engine illustrating an embodiment of the present invention.

FIG. 2 is a perspective view of an embodiment of steam generator.

FIG. 3 is an end view of an embodiment of steam generator.

FIG. 4 is an interior view of an airplane engine illustrating an embodiment of heat recovery system.

FIG. 5 is an interior view of an airplane engine illustrating an embodiment of heat recovery system.

FIG. 6 is a perspective view of an embodiment of steam generator.

FIG. 7 is an end view of an embodiment of steam generator.

FIG. 8 is a flow diagram of an embodiment of heat recovery system.

FIG. 9 is a flow diagram of an embodiment of heat recovery system.

FIG. 10 is a cross-section of the exhaust nozzle of a jet engine showing features of a preferred embodiment of the invention.

FIG. 11 is a block diagram showing key components of a prior art engine bleed air system.

FIG. 12 is a block diagram showing key components of an embodiment of the present invention.

### DETAILED DESCRIPTION OF THE INVENTION

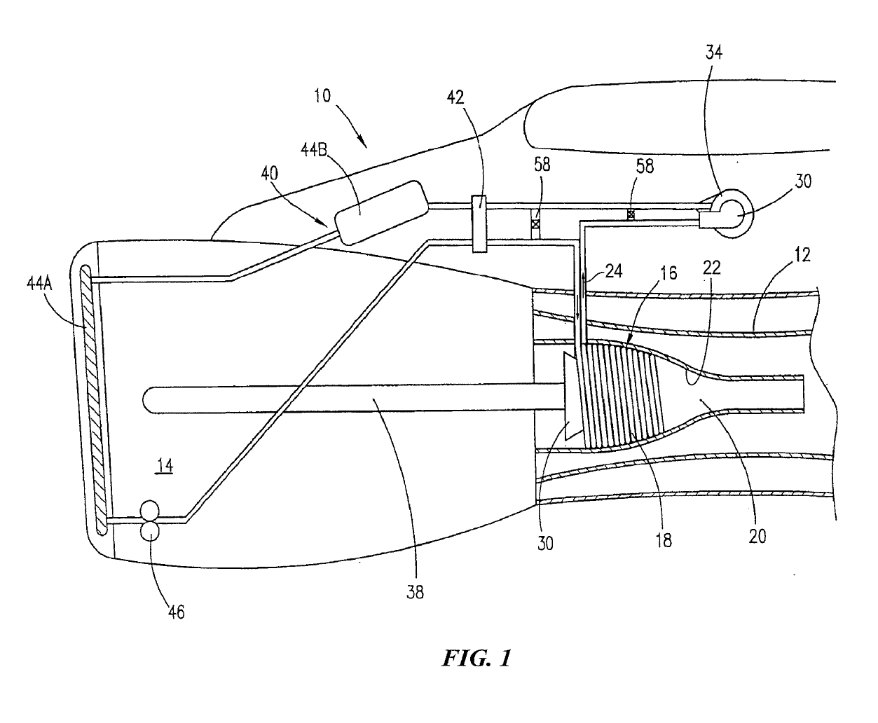

FIG. 1 shows a heat recovery system 10 utilizing exhaust nozzle 12 of engine 14 is disclosed. Heat recovery system 10 is designed to utilize otherwise wasted energy from exhaust gas which is expelled through exhaust nozzle 12. Heat recovery system 10 can be installed in gas turbine engines for use in aircraft, marine vessels, and any other device having a gas turbine engine.

Engine 14 is equipped with heat recovery system 10 which has a heat exchanger positioned inside the exhaust nozzle 12. This heat exchanger serves as a steam generator because it heats a coolant and converts that coolant from liquid to gas form during normal operations—the coolant is not typically water, as explained below, but the unit is identified as a steam generator because of the phase transfer that occurs during normal operation. The steam generator 16 can be a substantially hollow coil 18, positioned around the outer surface of the centerbody 20. Additionally or alternatively, the coil 18 may be positioned around the inner surface 22 (as shown in FIG. 1) of the centerbody 20. Coil 18 may have a circular cross section, a substantially rectangular cross section or any other shape which facilitates movement of a fluid 24.

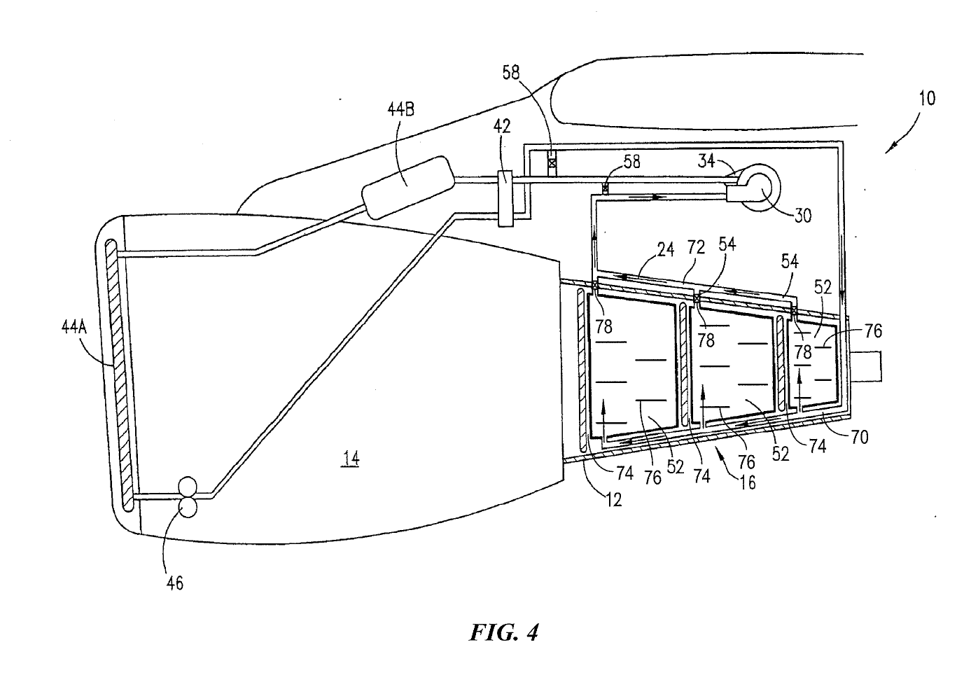

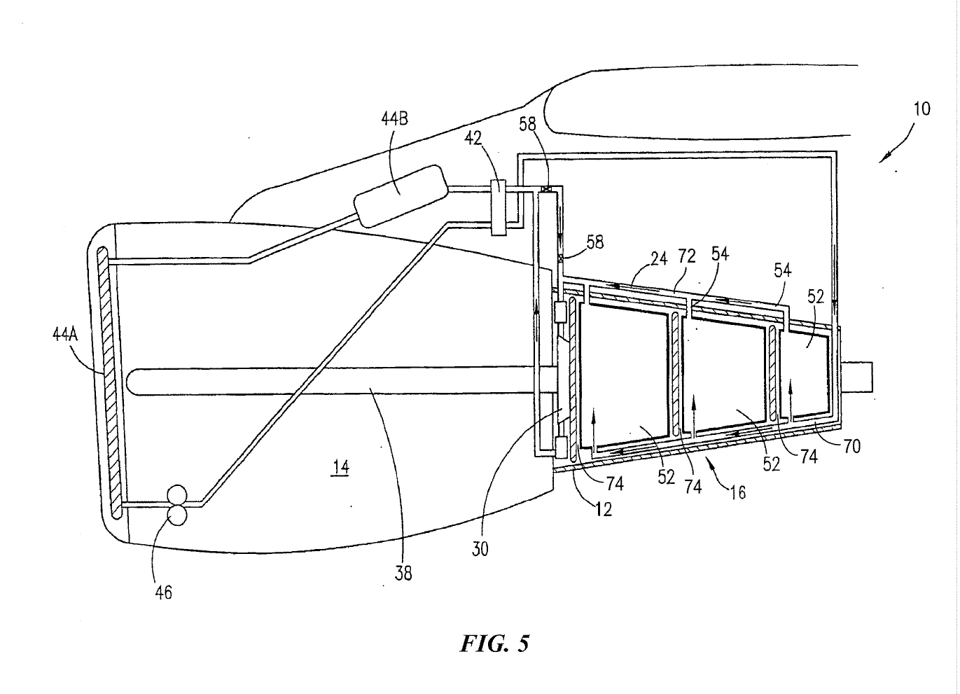

Alternatively, steam generator 16 can be a plurality of heat exchanger jackets 52 (see FIGS. 4 and 5) positioned between inner skin 48 and outer skin 50 of exhaust nozzle 12. Specifically, jackets 52 can be substantially circumferentially disposed within the exhaust nozzle 12 such that a plurality of passageways 54 can be created through which fluid 24 can flow. Jackets 52 can be two sheets 56 of light-weight, heat resistant material welded together to allow fluid 24 to freely circulate between sheets 56. Jackets 52 can be composed of Inconel, titanium, or aluminum alloy, as will be explained in more detail below.

Fluid 24 enters steam generator 16 in a liquid state. Fluid 24 is preferably an organic-based fluid. Fluid 24 should have a high allowed operating temperature to help heat recovery system 10 reduce entropy loss during heat exchange, evaporation and vapor transfer which results in a higher cycle efficiency of heat recovery system 10. Fluid 24 can be R245fa, R113, or R410a, with R245fa exhibiting the highest thermal efficiency.

The exhaust nozzle 12 can be fitted with a plurality of fins such that the fins are in contact with exhaust gas. These fins or ribs can be attached to inner skin 48 of exhaust nozzle 12 such that fins provide additional surface area for heat transfer from hot exhaust gases to steam generator 16, thereby increasing energy output of heat recovery system 10.

Vaporization of fluid 24 will cause pressure to build in steam generator 16. As vapor exits at about 3.89 Kgs/sec and 182 psi in the preferred embodiment, vapor will escape steam generator 16 and will travel to at least one turbine generator 30. Between steam generator 16 and turbine generator 30, a flow control valve 58 can be situated to regulate flow of vapor to turbine generator 30. The flow control valve 58 also controls the pressure of the vapor entering the turbine generator 30. FIG. 1 shows two possible locations for the flow control valve 58, either between the inlet and outlet fluid lines of the turbine generator, or between the outlet line of the turbine generator and the inlet line of the steam generator. Either or both of these valve locations may be used. If both are used, it is possible to achieve more control over the flow rates and temperatures within the system. In most designs, however, a single flow control valve will be sufficient. It is also possible to position the flow control valve 58 within the inlet line to the turbine generator, though in this configuration, the valve acts as a throttling valve rather than a bypass. Either approach will work in most situations.

As explained below, the flow control valve 58 is part of a control system used to maintain the coolant temperature below a design setpoint. This setpoint is selected to allow use of aluminum alloy components in the turbine generator 30 and possibly the steam generator 16, as well. Use of such material reduces the weight of the system, which is desirable for a retrofit system to be installed on an aircraft.

In its most basic form, turbine generator 30 is a device for converting fluid flow and pressure into mechanical energy. As vaporized coolant crosses turbine generator 30, the vapor will lose pressure and the drop in pressure can be used to drive turbine generator 30, which generates energy that can be used to power external devices. Thus, the pressure drop across turbine generator 30 can be used to power a utility 32. A 3 to 4 stage aluminum blisk type turbine generator with the ability to rotate at about 20,000 to 25,000 RPM may be utilized. The present invention includes specially-designed components that allow for use of aluminum-alloy components in the turbine generator, as explained in more detail below.

In one embodiment, utility 32 can be a generator 34. The turbine generator 30 drives generator 34 to produce electricity. The electricity from generator 34 can be used to power a compressor 36. Compressor 36 can be connected to an aircraft's air conditioning and pressurization system, both of which are part of the environmental control system or ECS. Additionally, generator 34 can be connected to aircraft electrical system 60, pump 62, or any other system which is electrical in nature.

In a second embodiment, utility 32 can be engine shaft 38. In the second embodiment, the energy recovered by steam generator 16 can be used to turn turbine generator 30 and directly power engine shaft 38 such that engine utilizes less fuel to produce the same amount of work. In this embodiment, turbine generator 30 can be coupled to engine shaft 38 by mechanical means through a fuse link which can operate as a safety device because the fuse link will break if turbine generator 30 fails.

After the vapor exits turbine generator 30, it will travel to a condenser 40 where vapor will be condensed into a fluid. The condenser 40 may be a single component or multiple components. In one embodiment, condenser 40 comprises a precooler 42 which reduces the temperature of the vapor. From precooler 42, vapor can flow into one or more condensers 44. In a preferred embodiment, the condenser includes a primary condenser 44A (which can serve as the engine cowling de-icing system, as explained below) and a secondary condenser 44B, though more or fewer condensers 44 may be utilized according to system requirements.

In FIG. 1, the condenser 40 is shown generally, while a primary condenser 44A and secondary condenser 44B are shown specifically. In later figures, the general reference to condenser 40 is not shown. It should be understood that the invention may include a single condenser 40 or a plurality of condensers, such as the primary and secondary condensers shown in FIGS. 1, 4, and 5.

A fluid pump 46 is provided to move the fluid from the condenser 40 to steam generator 16. Fluid pump 46 may be provided between condenser 40 and the steam generator 16 or it may be internal to condenser 40. Similarly, there may be multiple pumps 46, if desired. In any case, pump 46 moves fluid 24 back to steam generator 16. In a preferred embodiment, fluid pump 46 is electrically powered. Additionally, heat recovery system 10 can be fitted with another pressure control device 58 which can be situated to regulate flow of vapor as it returns to steam generator 16. Pressure control device 58 can also direct vapor to bypass turbine generator 30 if vapor flow or pressure reach a set level.

In operation, steam generator 16 will utilize the heat of the gasses exiting exhaust nozzle 12 to vaporize fluid 24. Vaporized fluid 24 will power one or more turbine generators 30. From turbine generator 30, the vapor will be condensed by condenser 40 and returned to steam generator 16 by pump 46. turbine generator 30 will power one or more utilities 32, such as generator 34 or engine shaft 38.

The design of a steam cycle system for use with an aircraft creates numerous challenges. The system must be lightweight, because added weight will reduce the passenger or cargo carrying capability of the aircraft and will cause an increase in fuel consumption and exhaust emissions. The system should be light enough so that it has a negligible impact on the aircraft's performance and capabilities.

The system also must be compact so that it will fit within the existing space near the aircraft's jet engines. Ideally, the key steam cycle components will be located within the engine housing or inside the pylon/strut that supports the engine.

Because the steam generator 16 of the present invention will be located inside the jet engine exhaust nozzle 12, the steam generator 16 must be constructed of materials capable of withstanding very high temperatures (e.g., 700-800° K.). Inconel and other alloys are often used for aircraft jet engine components because it is strong and can withstand very high heat environments. But Inconel is much heavier than aluminum alloys and, therefore, adding a steam generator made of Inconel might add too much weight. The present invention may employ a steam generator 16 positioned between the Inconel skins of the exhaust nozzle 12, which would shield the steam generator components somewhat from the extreme temperature of the exhaust gases. This design, together with the use of a refrigerant that operates at a lower temperature, allow use of aluminum alloy components (or other lower-weight materials) for some of the key components of the steam generator. These lower-weight materials might include a silicon-based polymer material for some internal components or a nylon-based material or any other suitable material that is strong, relatively heat-resistant, and durable. Aluminum alloy is preferred, but other materials may also be used so long as they can withstand the temperatures and are relatively lightweight.

As described above, the invention may use one or both of two general embodiments for the steam generator 16. In FIGS. 1-3, a steam generator 16 is shown with tubes wrapped around the inner surface of the exhaust nozzle center body 20. Alternatively, in FIGS. 4-5, a steam generator 16 is shown with circumferential heat exchange plates (also referred to herein as jackets) 52 positioned within the outer shroud of the exhaust nozzle 12. Design analysis shows that the latter design generates substantially more heat transfer and thus energy for use by the system. For that reason, the design shown in FIG. 5 is preferred. It is, however, possible that for some applications, the centerbody-wrapped steam generator design illustrated in FIG. 1 will provide adequate performance.

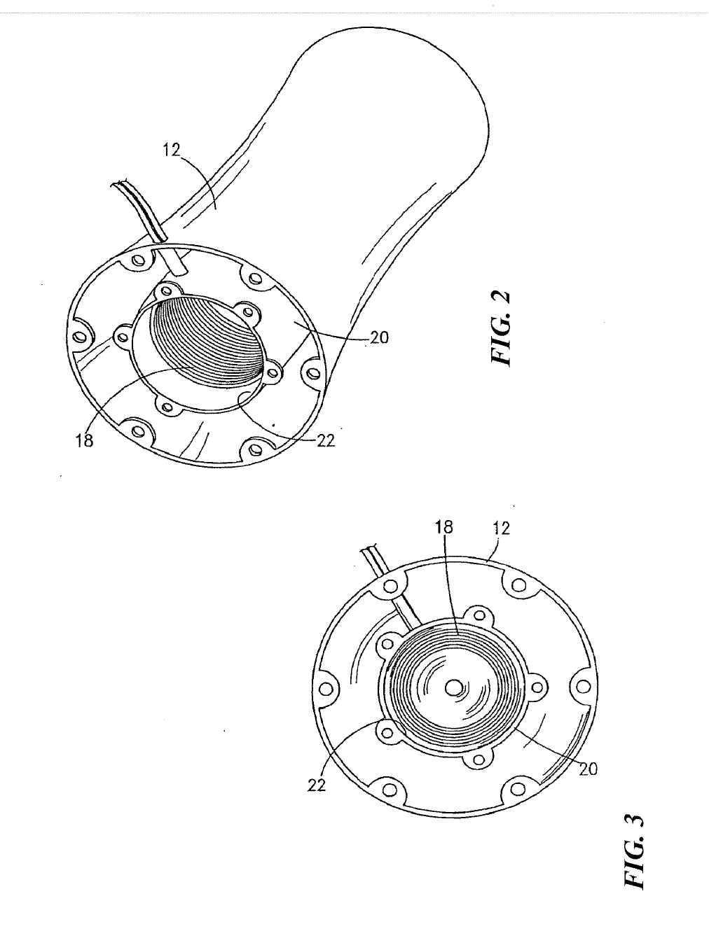

FIGS. 2-3 shown different views of the exhaust nozzle 12 and centerbody 20. The steam generator 16 is positioned along the inner wall of the centerbody 20 in these embodiments. Note that the coils must pass through the outer region of the nozzle 12. These lines would then connect to the turbine generator and fluid pump (not shown in FIGS. 2-3). It should be understood that the steam generator 16 shown in FIGS. 2-3 could also be positioned around the outer surface of the centerbody 20. This change would not fundamentally alter the configuration shown in these figures.

Each of the plate heat exchangers 52 shown in FIGS. 4, 5, and 7, are in the general shape of the letter “C”. This aspect of the design is best shown in FIG. 7, where two of the “C” shaped plates are shown in cross section. Six total plates are used in a preferred embodiment, with three on each site of the exhaust nozzle 12. The liquid coolant 24 from the condenser (items 44A and 44B in FIGS. 4-5) enters through the inlet manifold 70, which extends along the lower side of the exhaust nozzle shroud 12. The liquid coolant 24 then moves into the heat exchange plates 52 and rises up and around the nozzle shroud to an upper exhaust manifold 72.

The plates are sandwiched between the inner wall/skin 48 and outer wall/skin 50 of the exhaust nozzle shroud. These walls or skins typically are made of Inconel alloy to provide maximum strength and heat resistance. The steam generator plates 52, on the other hand, may be made of aluminum alloy because the temperature is not as extreme due to the Inconel skin 48 positioned between the plates and the hot exhaust gases. This allows for a large reduction in the weight of the system.

The exhaust nozzle shroud 12 typically has a series of circumferential stiffening rings 74 for added strength and rigidity. In a preferred embodiment, six heat exchange plates 52 are positioned within the spaces between the stiffening rings 74. Three such plates are shown in FIGS. 4-5, which shown one side of a preferred embodiment. Internal baffles 76 may be used within the plates 52 to create more heat exchange surface area and also to facilitate flow balancing. Individually controllable exhaust valves 78 may be used with each heat exchanger plate 52 to further balance the flow rates through the plates.

A series of tubes wrapped around the inside surface of the exhaust nozzle is another embodiment of a steam generator for the invention. This embodiment is not separately shown in the figures, but it is similar to the design seen in FIG. 1. Instead of wrapping the heat exchange tubes around the inner surface of the center body 20, as shown in FIG. 1, the tubes would be wrapped around an inner surface of the exhaust nozzle shroud 12. In both instances round or square tubes could be used, but square tubing is preferred because it provides more heat transfer surface. In this embodiment, however, the circumferential tubes might extend upward from an inlet manifold 70, as explained above, to an exhaust manifold 72. So rather than being a continuous wrap of tubes like that shown in FIG. 1, in this embodiment, there would be numerous tubes, with each extending around an arc of less than 180°.

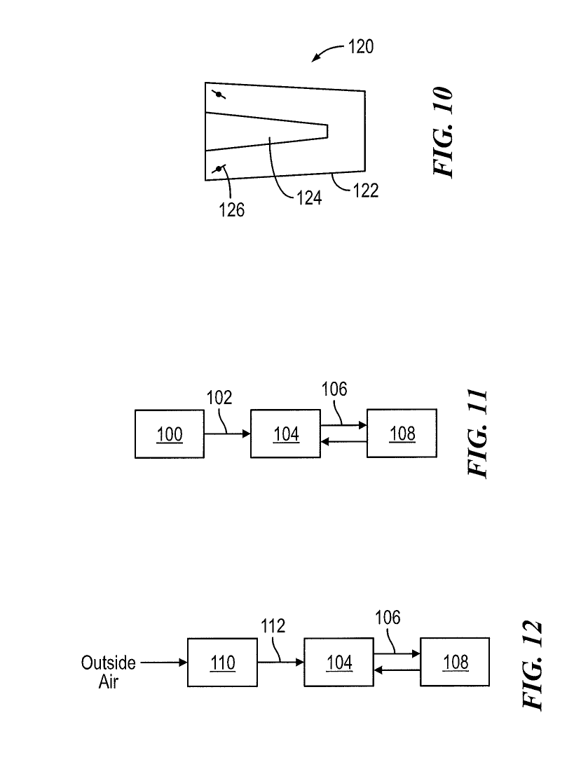

In the preferred embodiment having a plurality of circumferential heat exchanger plates 52 (i.e., that shown in FIGS. 4-5), additional structural components may be desirable to reduce the temperature of the exhaust gases closest to the exhaust nozzle shroud 12. For example, as shown in FIG. 10, a diverter 126 may be installed near the leading end of the exhaust nozzle 120 in order to divert some of the exhaust gases away from the shroud 122. The diverter 126 could be adjustable, and thus moved into a blocking position during periods of extremely high engine demand (e.g., during takeoff and initial ascent). During other, more typical, operating conditions, the diverter 126 could be positioned to allow full flow of exhaust gases over the areas where the heat exchanger plates are located. When engaged, the diverter 126 would direct a greater portion of the exhaust gases over the exterior surface of the centerbody 124. The diverter 126, therefore, could be used to increase the heat transfer in an embodiment with tubes around the exterior surface of the centerbody 124. Indeed, an alternative embodiment might have heat exchange plates or tubes along the inner surface of the shroud 122 and around the outer surface of the centerbody 124. In this embodiment, a diverter 126 could be used to maintain a desired heat transfer between the two separate heat exchange components.

The coolant fluid in the steam generator 16 will go from liquid to gas form as it moves through the heat exchanger plates or tubes. Thus, the upper exhaust manifold 72 shown in FIGS. 4, 5, and 7, is configured to allow the flow of steam or evaporated coolant. This manifold, therefore, may have a larger volume than the lower, inlet manifold 72.

The specific design and materials used for the steam generator components will vary. For some aircraft, it may be necessary to use Inconel or some other similarly heat resistant material, even though such use would increase the weight of the system. In other settings, particularly with smaller aircraft having a lower power demand for the cabin environmental control system, aluminum alloy may be suitable. The specific needs and conditions of each particular system will determine which type of materials will be needed.

The turbine generator 30 of the present invention must be compact and capable of generating sufficient electrical energy to supply the air compressors that supply outside air to the cabin. For a common commercial aircraft, the generator should supply between 150-200 kW of electrical energy. In a preferred embodiment, a four blade turbine, with the bladed rotor made from a single piece of aluminum alloy, is used. One preferred embodiment uses a turbine with a designed rotational speed of 20,000 rpm with approximate outer dimensions of 12″×12″×31″. This sizing allows for the turbine generator to be installed within the engine support pylon. By using a suitable coolant (e.g., R245fa) and a proper steam generator design, the entering coolant temperature can be maintained at a low enough point to use aluminum alloy for the turbine components.

The preferred turbine weighs less than 300 pounds and uses relatively large turbine blades with only three or four stages. This design reduces the complexity of the turbine, thus lowering production costs and increasing reliability. In a preferred embodiment, the minimum turbine blade height is 5 mm, and the entire rotor assembly, including blades, is machined from a single piece of metal.

The condenser is an air-cooled heat exchanger. During flight, this design works well because of the low air temperatures and the high air flow rate. When the present invention is used on the ground—for example when at a gate or during taxiing—the air temperature may be too high and the flow rate too low to provide the needed cooling in the condensers. A fan may be added to the system to supply sufficient air flow through the condensers during such conditions. If such a fan is included, the electrical demands of the fan must be added to the total system demands, which may require a larger steam generator and/or turbine generator. A condenser fan, however, is expected to be a low-power component and would not add much load to the system.

As an alternative to a fan for providing air flow through the condenser during low-speed operations, engine fan by-pass air may be ducted to the condenser to provide cooling air flow. In a retrofit of an existing engine bleed air system, the main condenser may replace an existing bleed air precooler.

The condensers of the present invention also allow for possible elimination of other systems and components from the aircraft, which will offset the added weight of the system. For example, the engine bleed air components may be removed, unless bleed air is used for deicing or other key systems. In many aircraft, the hot engine bleed air is routed to the outer, frontal area of the jet engine and along the leading edge of the wing to prevent icing. If the present invention is used, the condenser 44A (as shown in FIG. 1) may be positioned at the outer, frontal area of the jet engine. Indeed, the condenser 44A may be of a ring design and mounted around the leading edge of the engine housing, thus serving as both a condenser for the steam cycle and as a deicing system for the engine.

Additional condensers may be installed along the leading edge of the wing, thus serving a wing deicing components. If the present invention is designed in this manner, it may be practical to remove all components of the engine bleed air system from the aircraft. By using condensers positioned in different areas exposed to maximum air flow, the need for a supplemental condenser fan may be eliminated.

Because the present invention provides a source of electrical power at the engines, that power also could be used to power electrical heat strips along the leading edge of the wings or other surfaces where icing is a concern.

The specially-designed steam system of the present invention uses different size fluid lines at different stages of the system. This is done to tailor the lines to the needs of the system, thus reducing weight and wasted space. For example, the line between the turbine generator and the regenerator and condensers are large because these lines contain relatively low pressure vaporized coolant, which needs more volume to maintain a proper flow rate. Other lines are smaller, particularly those between the condensers and the steam generator, because those lines will contain liquid coolant. In one preferred embodiment, the low pressure vapor lines are 140 mm in diameter, while the liquid coolant lines are 40 mm in diameter. The ratio of the diameters of these lines is typically at least 2:1, that is the low-pressure vapor lines have a diameter that is at least twice as large as that of the liquid coolant and high-pressure vapor lines.

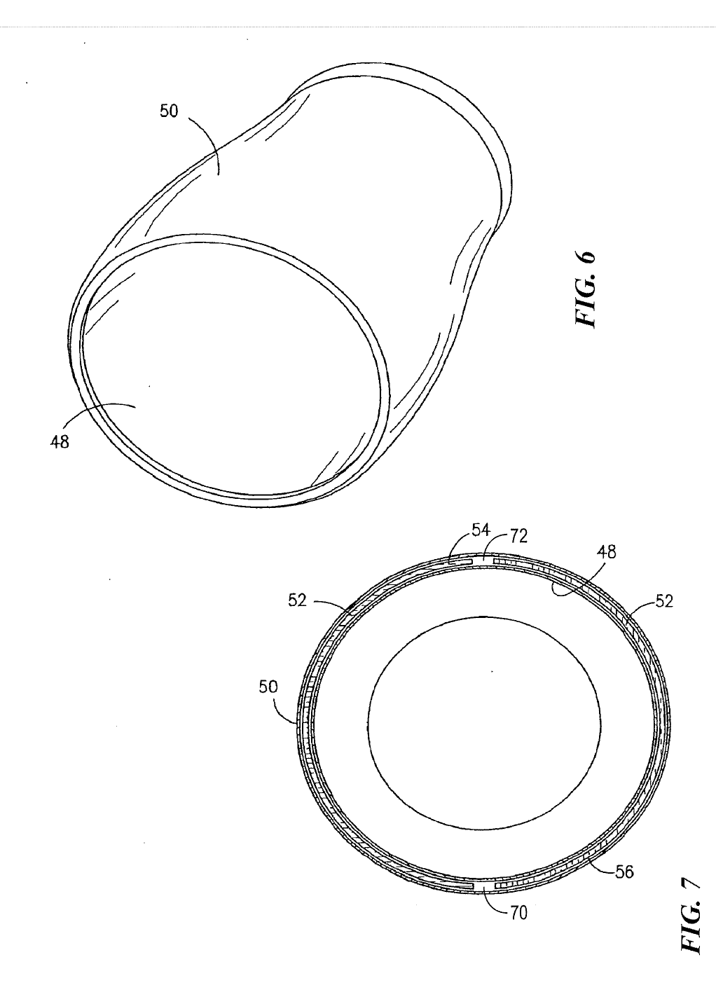

In a preferred embodiment, the present invention uses a continuous feedback system to control the coolant flow rate in the system so that the superheat temperature of the coolant is maintained below at design setpoint. This setpoint is selected to allow for use of aluminum alloy components in the turbine generator and possibly in the steam generator as well. A flow control valve 58 (see FIGS. 6-7) between the steam generator and the turbine generator is used to vary the flow rate to maintain a maximum inlet coolant temperature to the turbine generator.

When the engine operating conditions produce a higher temperature coolant exiting the steam generator, the flow control valve is opened to increase the system flow rate. When this is done, the coolant spends less time in the steam generator and therefore is not heated to as high a temperature. The deflector 126, described above, can be used together with the flow control valve to ensure that the coolant temperature entering the turbine generator is maintained below the design setpoint.

An additional efficiency gain is obtained by using a regenerator 42, as described above. This component increases the efficiency of the system, which allows for use of smaller and lighter components. The invention may be used without a regenerator 42, but this component is preferred.

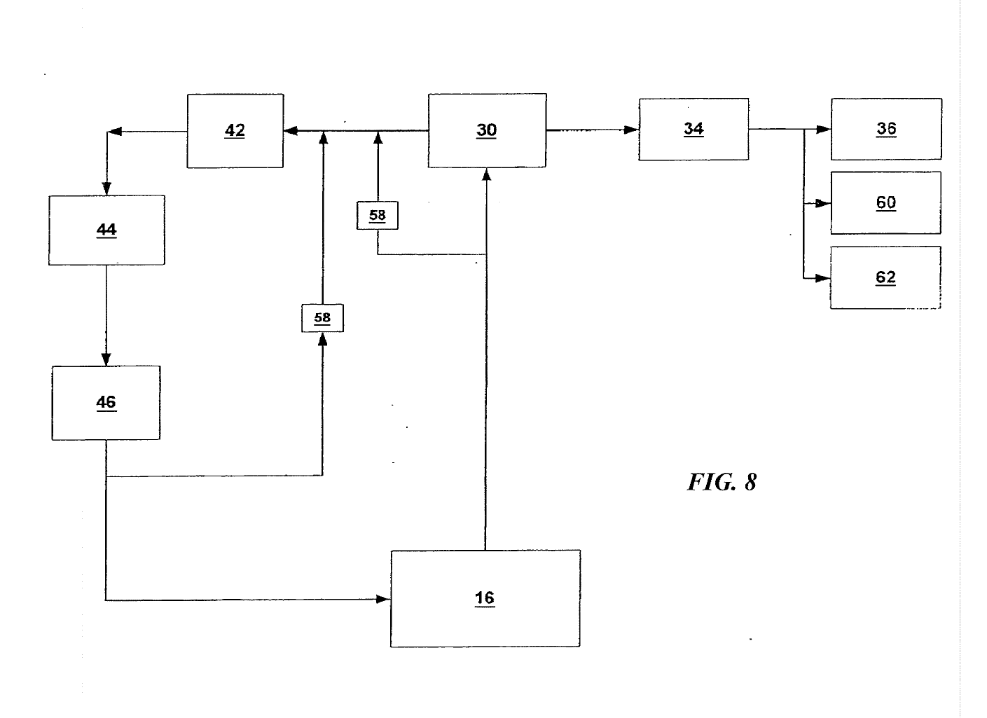

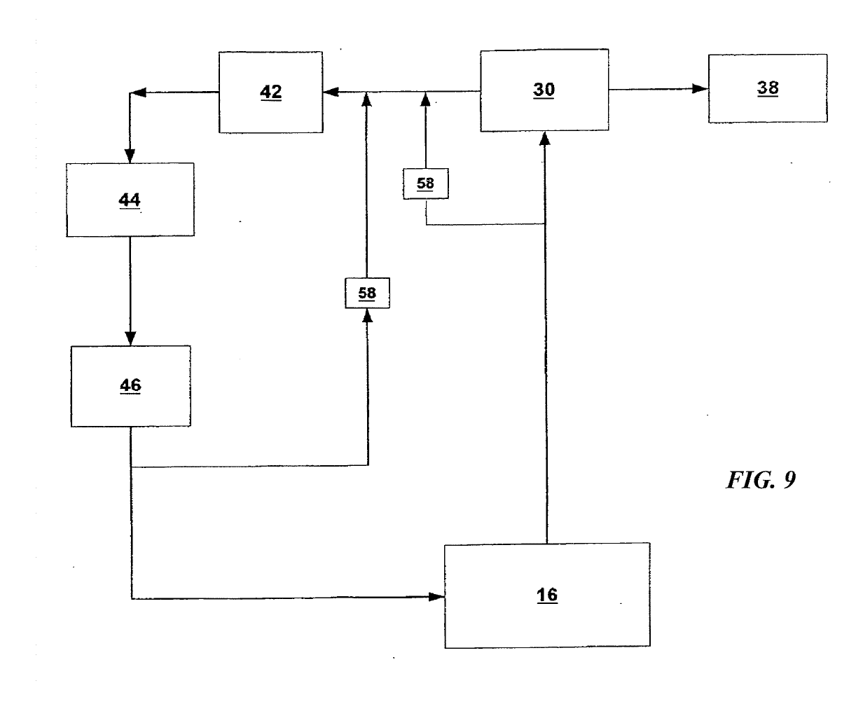

FIGS. 8-9 are block diagrams showing the key components of two embodiments of the present invention. In FIG. 8, the steam generator 16 supplies hot, vaporized coolant to the turbine generator 30, which powers a utility 34. This utility 34 may be an electrical generator, which supplies a plurality of electrical loads, 36, 60, and 62. In the alternative embodiment shown in FIG. 9, the turbine generator 30 is used to supply power back to the engine shaft 38, thus increasing the overall efficiency of the engine. Other components illustrated in FIGS. 8-9 are as described above.

In FIGS. 11 and 12, block diagrams illustrate the typical prior art aircraft environmental control system (ECS) operation and that of the present invention. In the traditional system, an aircraft jet engine 100 produces very high temperature and high pressure air. Some of that air is bled off (i.e., engine bleed air 102) and routed through ducts within the wings and body of the aircraft to the ECS 104, which is typically located in the belly section of the aircraft's body. The cabin air flow 106 is between the ECS 104 and the cabin 108. The ECS 104 filters, dries, and recirculates the air to and from the cabin 108. Because the engine bleed air 102 is at a very high temperature and moisture, it must be cooled and dried before it enters the cabin 108.

The prior art design has been used almost exclusively for decades. This system, however, has significant drawbacks. The engine bleed air 102 is contaminated by engine air compressor oil, vaporized hydraulic fluid, and potentially exhaust gases. The ECS 104 attempts to remove and filter out these contaminants, but some contaminants typically enter the cabin when the traditional prior art design is used. The contaminant levels are typically low, but extended exposure to even low levels of these contaminants may cause health issues. Because the flight crews of commercial aircraft spend a great deal of time in the aircraft, these persons are at a higher risk of neurological and other health problems due to use of the engine bleed air within the cabin 108.

The present invention provides an alternative. The specially-designed steam cycle described above is installed within the jet engine and engine support pylon. This system is used to generate electrical energy. Electrical cables are routed from the engine area to the aircraft's belly section where the ECS 104 is located. Electric air compressors in the ECS 104 use outside air and are powered by the electricity generated by the specially-designed steam cycle components described above. The compressors also heat the air, which is then dried (if necessary) and supplied to the cabin 108. The ECS 104 includes filters and control components to either recirculate cabin air or mix cabin air with outside air via the air compressors.

In the improved system provided by the present invention, no air ducts are routed from the engine area to the aircraft's belly section. Instead, electrical cables are routed, which takes less space and can be easily done as a retrofit. All aspects of the present invention are designed to allow for easy installation in an existing aircraft. This easy retrofit capability allows aircraft owners to replace the engine bleed air system on their aircraft are a reasonable cost and with a reasonably simple process.

In a preferred embodiment, there are two separate ECS 104, a left ECS and a right ECS. The left ECS has air compressors powered by a steam cycle mounted on an engine from the left side of the aircraft, while the right ECS is powered by the steam cycle system from a right side engine. Within each ECS, there are preferably two electrical air compressors. A single ECS, running a single air compressor, is sufficient to handle the cabin air needs under most operating conditions. This embodiment, therefore, provides for two-levels of redundancy and thus results in a highly-reliable system.

The cabin air compressors of the present invention may be supplied outside air via a ram air scoop. Such a scoop may be designed with a variable baffle or duct that can be exposed more or less to the flow of air. By using a ram air process (i.e., allowing the aircraft's speed through the air generate a forceful flow of air into the air compressor inlet manifold), less energy is needed to power the air compressors. This reduces the power needs of the steam cycle system, and thus reduces the size and weight of the components needed.

The ECS 104 may include both heating and cooling components. The cabin air may be heated by mixing in air from the air compressors, because the air exiting the compressors is typically 120° F. or more. The cabin air may be cooled, using air-to-air heat exchangers, with cooling air flow taken from outside air. The ECS also may include filters, drying, or humidifying components in order to condition the cabin air to make it comfortable and safe for passengers.

The embodiments shown in the drawings and described above are exemplary of numerous embodiments that may be made within the scope of the appended claims. It is contemplated that numerous other configurations may be used, and the material of each component may be selected from numerous materials other than those specifically disclosed. In short, it is the applicant's intention that the scope of the patent issuing herefrom will be limited by the scope of the appended claims.

1.-17. (canceled)

18. A system for recovering energy from the exhaust of an aircraft jet engine, the system comprising:
a. a steam generator having heat transfer surfaces positioned within an exhaust nozzle of an aircraft jet engine;
b. a turbine generator driven by vaporized coolant from the steam generator, wherein the turbine generator produces sufficient electrical energy to power an air compressor that supplies fresh, pressurized, outside air to a passenger compartment of the aircraft;
c. one or more air-cooled condensers that receives hot coolant from the turbine generator; and,
d. a pump that receives liquid coolant from the air-cooled condenser and supplies liquid coolant to the steam generator.

19. The system of claim 18, wherein the steam generator consists of a plurality of “C” shaped, plate-type heat exchangers positioned between an inner and outer skin of the exhaust nozzle.

20. The system of claim 18, wherein the exhaust nozzle further comprises a plurality of fins configured to increase the heat transfer from hot exhaust gases to the steam generator.

21. The system of claim 18, wherein a flow control valve is positioned between an outlet line of the turbine generator and an inlet line of the steam generator.

22. The system of claim 18, wherein the flow control valve is part of a control system configured to maintain the coolant temperature entering the turbine generator at or below a design setpoint.

23. The system of claim 18, further comprising a precooler positioned between the turbine generator and the one or more air-cooled condensers.

24. The system of claim 18, wherein one of the one or more air-cooled condensers is positioned at the outer, frontal area of the jet engine and is capable of serving as a de-icing system for the inlet cowl of the engine.

25. The system of claim 18, wherein one of the one or more air-cooled condensers is positioned along the leading edge of a wing of the aircraft and is capable of serving as a de-icing system for the wing.

26. The system of claim 18, wherein the pump is an electrical pump.

27. The system of claim 18, further comprising an adjustable diverter positioned within the exhaust nozzle and configured to control the flow of hot exhaust gases over the steam generator.

28. The system of claim 18, further comprising a fan configured to provide air flow to at least one of the one or more air-cooled condensers.

29. The system of claim 18, further comprising a continuous feedback system configured to control the coolant flow rate in the system so that a superheat temperature for the coolant is maintained below a design setpoint.

30. The system of claim 18, further comprising a regenerator positioned between the one or more air-cooled condensers and the steam generator, and configured to preheat the liquid coolant before it enters the steam generator and to precool the gas leaving the turbine generator before it enters the condensers.

31. The system of claim 18, further comprising electrical cables for supplying electricity from the turbine generator to the air compressor, the electrical cables routed from the jet engine area, through a wing of the aircraft, and to a belly region of the aircraft

32. The system of claim 18, wherein the turbine generator supplies electrical energy to a pair of air compressors, wherein the air compressors are mechanically connected to an environmental control system of the aircraft.

33. The system of claim 18, wherein the air compressor is supplied with outside air via a variable area scoop, wherein the scoop generates a ram-air feed to the air compressor during flight.

34. A steam generator designed for installation in an exhaust nozzle of a jet engine of an aircraft, the steam generator comprising:
a. an inlet flow manifold positioned along a lower side of the steam generator, the inlet flow manifold sized to allow flow of a coolant in liquid form;
b. an outlet flow manifold positioned along an upper side of the steam generator, the outlet flow manifold sized to allow flow of vaporized coolant and wherein the outlet flow manifold has a volume at least twice as large as the inlet flow manifold;
c. a plurality of “C” shaped heat exchangers positioned between the inlet flow manifold and the outlet flow manifold; and,
d. a means for controlling and balancing the flow of coolant through the plurality of “C” shaped heat exchangers.

35. The steam generator of claim 34, wherein the “C” shaped heat exchangers are made of an aluminum alloy, titanium, or other light-weight alloy capable of performing at temperatures above 400° C.

36. The steam generator of claim 34, wherein the “C” shaped heat exchangers are circumferential heat exchange plates.

37. The steam generator of claim 34, wherein the “C” shaped heat exchangers are positioned between stiffening rings of the exhaust nozzle.

38. The steam generator of claim 36, wherein the circumferential heat exchange plates contain internal baffles.

39. The steam generator of claim 34, wherein the means for controlling and balancing the flow of coolant through the plurality of “C” shaped heat exchangers comprises individual flow control valves positioned at the outlet of each “C” shaped heat exchanger.

40. A light-weight, compact turbine generator designed for installation within an engine pylon, and near an exhaust nozzle of a jet engine of an aircraft, the turbine generator comprising:
a. a rotor made from a single piece aluminum alloy, the rotor further comprising at least three sets of blades where the smallest set of blades are at least 5 mm in height; and,
b. a housing configured to contain and support the rotor, and wherein the turbine generator:
i. weighs less than 300 pounds;
ii. is designed to operate at or above 20,000 rpm; and,
iii. is designed to generate at least 150 kW of electrical power during normal use.

41. A method of retrofitting the environmental control system (ECS) of an aircraft having one or more jet engines, comprising:
a. installing a steam generator in an exhaust area of a jet engine;
b. installing a turbine generator near the jet engine, wherein the turbine generator produces at least 15 kW of electrical power;
c. installing one or more air-cooled condensers near the jet engine;
d. installing a fluid pump near the jet engine;
e. installing fluid lines between:
i. the steam generator and the turbine generator;
ii. the turbine generator and the condensers;
iii. the condensers and the fluid pump; and,
iv. the fluid pump and the steam generator;
f. installing one or more air compressors in a belly area of the aircraft, wherein the air compressors are configured to receive outside air and supply hot, compressed air to the ECS which in turn provides filtered, conditioned and pressurized air to an interior compartment of the aircraft; and,
g. installing electrical lines to supply electrical power from the turbine generator to the one or more air compressors.

42. The method of claim 41, where the retrofit process includes repeating all steps on a right side and a left side of the aircraft, such that a jet engine on the right side produces the energy to supply a first ECS and a jet engine of the left side produces the energy to supply a second ECS.
